(19) United States
(12) Patent Application Publication
(10) Pub. No.: US 2010/0117462 A1
(43) Pub. Date: May 13, 2010

(54) Damper Power-Generating System

(76) Inventors: June-Chi WANG, Tanzih Township (TW); Hon-Wei Hsiao, Ti-an Township (TW); Dun-Zen Jeng, Taichung City (TW); Chao-Ching Wang, Lu-chao Township (TW)

Correspondence Address: HDLS Patent & Trademark Services, P.O. BOX 220746, CHANTILLY, VA, 20153-0746, US

(21) Appl. No.: 12/269,760

(22) Filed: Nov. 12, 2008

(51) Int. Cl. H02K 7/06

(52) U.S. Cl. 310/20

(57) ABSTRACT

A damper power-generating system includes a damper, a driving apparatus, and a generator. The driving apparatus simply consumes energy to do work for generation of electric power. That is, the work is done by utilizing the displacement due to the strong up-and-down vibration within a damper, wherein the displacement due to the up-and-down vibration drives a set of gear racks, which, in turns, drives gears having a one-way driving apparatus, so that rotation can be achieved in one direction, and, further, buffering springs and accelerative gears are used, so that speedy and uniform rotation can be achieved.

### BACKGROUND OF THE INVENTION

1. Field of the Invention

The present invention relates to a damper power-generating system and, particularly, to a damper power-generating system that does work by utilizing the displacement due to the up-and-down vibration within a damper in use, wherein the motion is damped to do work for generation of electric power.

2. Descriptions of the Related Art

The most common prior art that utilizes up-and-down vibration to do work is the technology of the piston engine. It uses a crank shaft and a cam shaft to drive doing work, but it is not applicable to the case that the up and down vibratory strokes in a damper are not uniform.

Since the conventional technology has such drawbacks as described above, an improvement is required urgently.

In view of the above difficulties associated with the conventional technology, the present inventor, through a long-term study and practice, has set about the work of improvement and innovation that provides the present damper power-generating system. The damper power-generating system is composed of common mechanical apparatus, one-way gears, alleviate operating apparatus, accelerative rotating apparatus and generators. It functions mainly to do work for power generation, by utilizing the vibration in a damper in which the motion should be damped. The generated power can be used directly for carriers so as to save the extra cost for preparation of electricity. It will be much more prominent in environmental protection, as compared with other types of generators.

### SUMMARY OF THE INVENTION

The primary aspect of this invention is to provide a damper power-generating system that may do work by utilizing the displacement due to the up-and-down vibration within a damper in use, wherein the motion to be damped is used to do work for generation.

Another aspect of this invention is to provide a damper power-generating system that may solve the problem of non-uniform vibratory strokes and inconstant reciprocative displacement, so that the motion to be damped is used effectively to do work and the energy due to the work is converted to electric power by a simple mechanical construction.

A further aspect of this invention is to provide a damper power-generating system that has advantageously easy fabrication, simple maintenance, and low cost.

A damper power-generating system fulfilling the aspects of the present invention comprises a damper, a driving apparatus, and a generator.

The damper has an outer tube, and an inner tube being movable upward and downward within the outer tube.

The driving apparatus is disposed on the outer tube by means of a connecting base and has an active bar pivoted therein, wherein the active bar has one end extending out to be movably placed on the inner tube and the other end partially having a gear rack formed on at least one side thereof, the gear rack being engaged with at least two gears each of which has a one-way driving apparatus, the gears further directly or indirectly driving passive gears to rotate and the passive gears being engaged with a driving gear, so that the driving gear, together with a driving shaft, has a continuous one-direction rotation output.

The generator is directly or indirectly connected to the driving gear, for generating electric power.

### BRIEF DESCRIPTION OF THE DRAWINGS

The drawings disclose an illustrative embodiment of the present invention which serves to exemplify the various advantages and objects hereof, and are as follows.

FIG. 1 is a schematic drawing of the appearance of the damper power-generating system according to the present invention.

FIG. 2 is a side view of the appearance of the damper power-generating system.

FIG. 3 is an internal configuration drawing of the driving apparatus of the damper power-generating system.

FIG. 4 is an elevation view of the internal configuration of the driving apparatus of the damper power-generating system.

FIG. 5 is a schematic drawing of the internal operation of the driving apparatus of the damper power-generating system.

FIG. 6 is an internal configuration drawing of the alleviate operating apparatus and accelerative rotating apparatus of the damper power-generating system.

FIG. 7 is a side perspective view of the driving apparatus and the alleviate operating apparatus of the damper power-generating system.

FIG. 8 is an exploded view of the damper power-generating system.

FIG. 9 is a schematic drawing of the appearance of a second embodiment of the damper power-generating system.

FIG. 10 is an internal configuration drawing of the second embodiment of the driving apparatus of the damper power-generating system.

FIG. 11 is a schematic side view of the damper power-generating system.

### DESCRIPTION OF THE PREFERRED EMBODIMENT

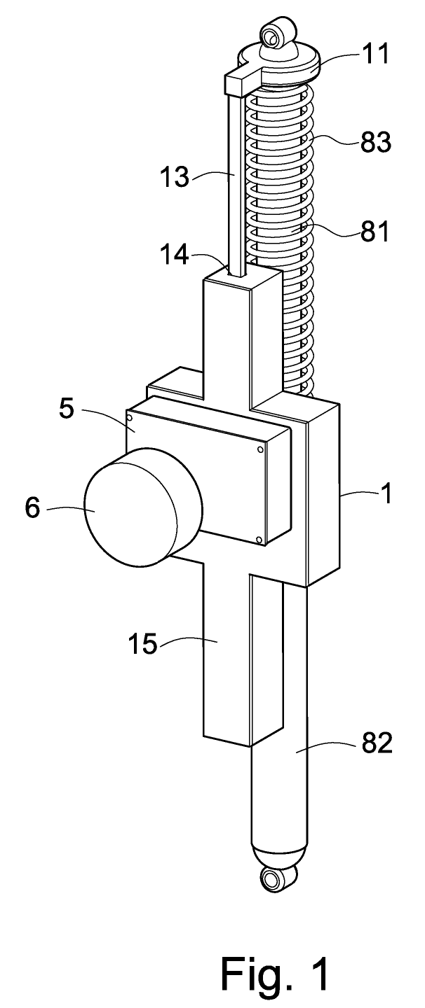

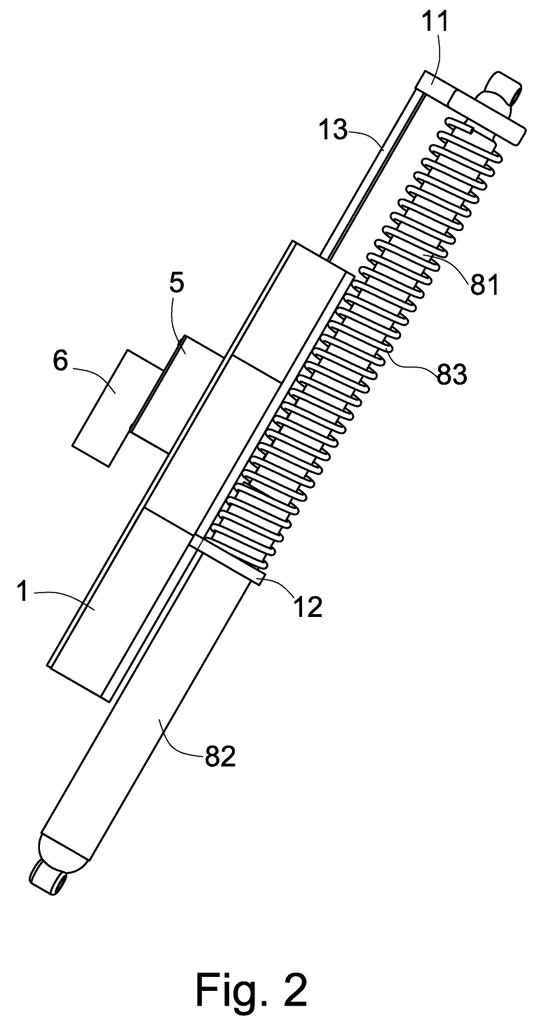

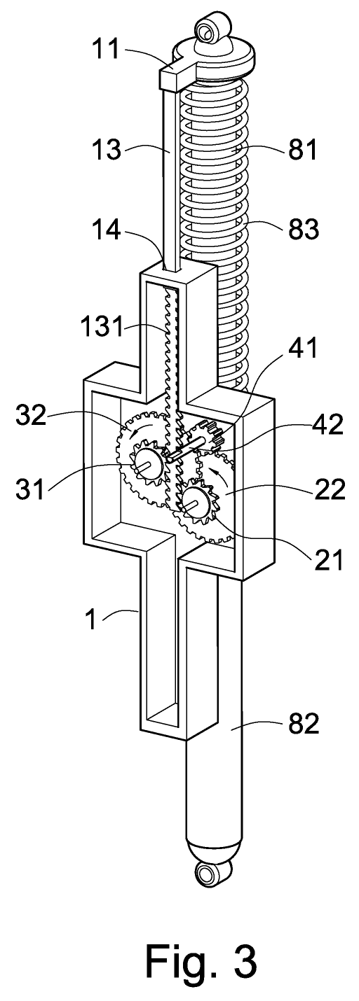

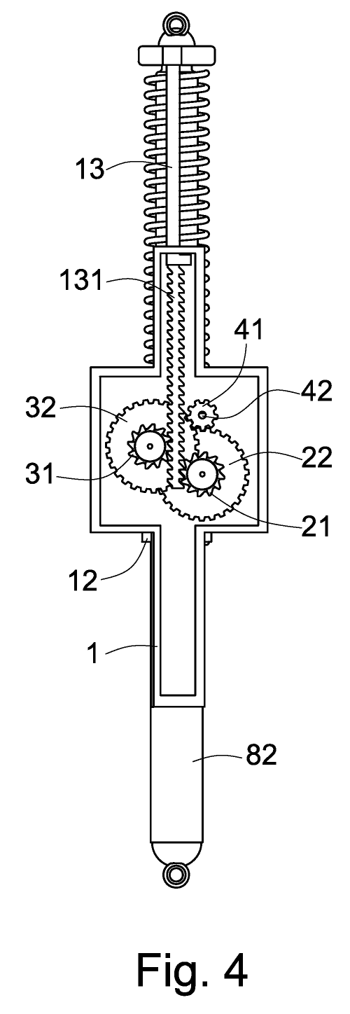

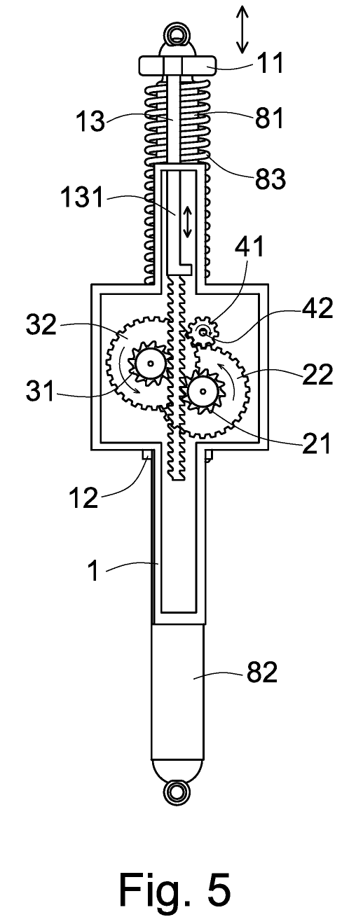

Referring to FIG. 1 to FIG. 5, the damper power-generating system according to the present invention is shown. Those figures are, respectively, a schematic drawing of the appearance, a side view of the appearance, an internal configuration drawing of the driving apparatus, an elevation view of the internal configuration of the driving apparatus, and a schematic drawing of the internal operation of the driving apparatus.

The damper has an inner tube 81 and an outer tube 82. A fixing base 11 is disposed at the top end of the inner tube 81; a connecting base 12 is disposed on the outer tube 82 and is connected to a driving apparatus 1; a spring 83 has one end connected to the fixing base 11 and the other end connected to the top end of the outer tube 82; the fixing base 11 is connected to an active bar 13 extending through a movable hole 14 of the driving apparatus 1 and having a two-face gear rack 131 formed within the driving apparatus 1. According to the present invention, the active bar 13 can be coupled to the inner tube 81 by means of the fixing base 11; the driving apparatus 1 can be coupled to the inner tube 81 by means of the connecting base 12. As the up-and-down reciprocative motions in the damper are compressed, the inner tube 81 and the outer tube 82 produce relative displacement so as to make the driving apparatus 1 do work. According to the present invention, the fixing base 11 is used for producing relative displacement associated with displacement of the gear rack 131 of the active bar 13 and the energy to be damped is used as mechanical energy input to a generator 6, so that the driving apparatus 1 and the generator 6 according to the present invention have function in place of all or part of function a damping apparatus has.

According to the present invention, the driving apparatus 1 has a first gear 21 and a second gear 31 each having a one-direction rotation driving apparatus so that the reciprocative motion of the active bar 13 is converted to one-direction rotation outputs of the shafts of the first gear 21 and the second gear 31. Besides, the shaft of the first gear 21 and a first passive gear 22 are coaxial and structured to move; the shaft of the second gear 31 and a second passive gear 32 are coaxial and structured to move.

When the gear rack 131 moves downward, the first gear 21 is driven, structurally and coaxially with the first passive gear 22, to rotate counter-clockwise. On the contrary, when the gear rack 131 moves upward, the first gear 21 rotates clockwise and, therefore, the first passive gear 22 cannot be driven synchronously. Further, the first passive gear 22 is engaged with a driving gear 41 synchronously, so that the driving gear 41 rotates clockwise.

When the gear rack 131 moves upward, the second gear 31 is driven, structurally and coaxially with the second passive gear 32, to rotate counter-clockwise. On the contrary, when the gear rack 131 moves downward, the second gear 31 rotates clockwise and, therefore, the second passive gear 32 cannot be driven synchronously. Further, the second passive gear 32 is engaged with the driving gear 41 synchronously, so that the driving gear 41 rotates clockwise.

According to the present invention, the first passive gear 22 and the second passive gear 32 rotate in fixed direction. Both of them do not change the rotation direction as the first gear 21 or the second gear 31 change the rotation directions.

Thus, the driving gear 41, together with the driving shaft 42, rotates clockwise all the time, whether the damper is compressed or is restored. The driving shaft 42 extends through a cover 15 of the driving apparatus 1 and to the outside of the driving apparatus 1, and then is connected to the generator 6 or to an alleviate operating apparatus 5 and an accelerative rotating apparatus in between.

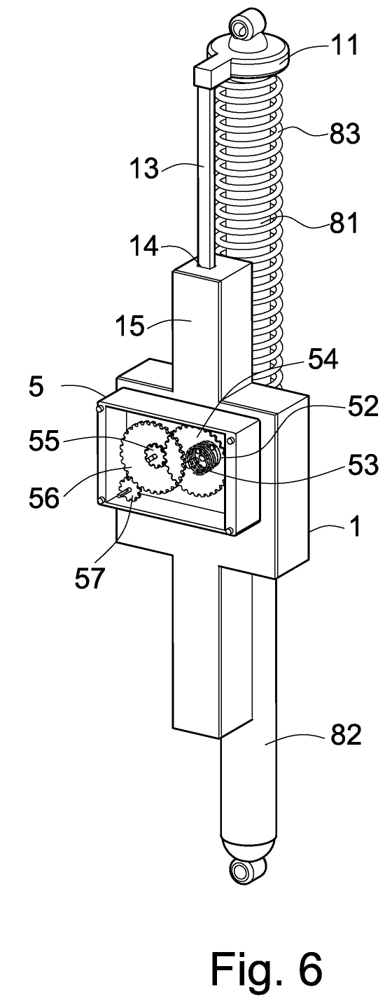

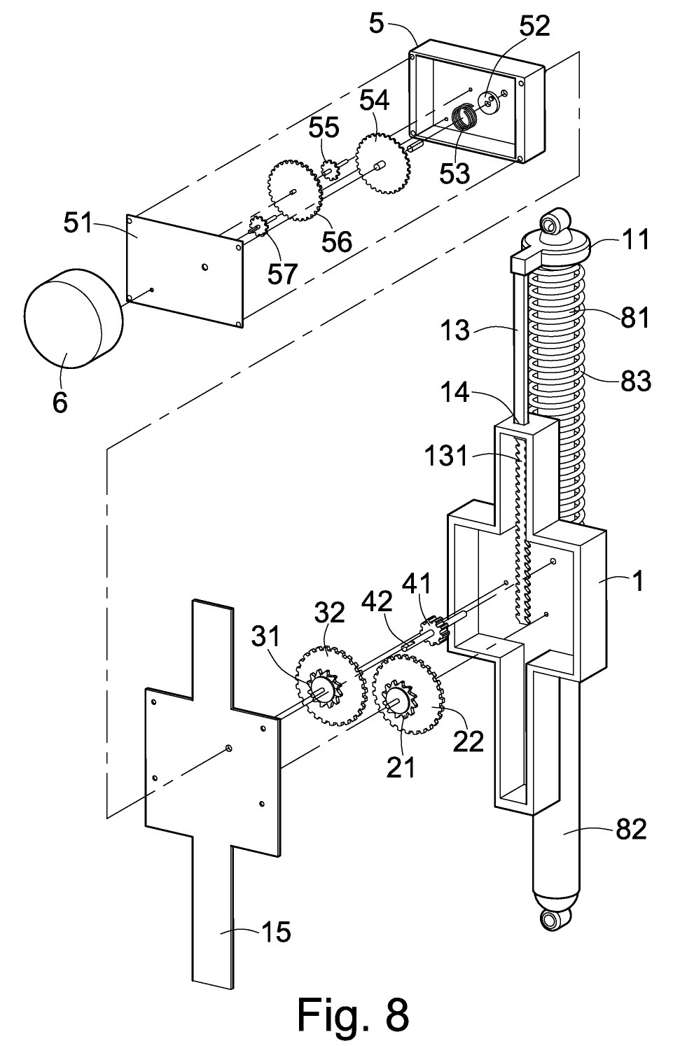

Referring to FIG. 6 to FIG. 8, the alleviate operating apparatus and an accelerative rotating apparatus of the damper power-generating system according to the present invention are shown. Those figures are, respectively, an internal configuration drawing, a side perspective view, and an exploded view. For convenience, the cover 51 of the alleviate operating apparatus 5 is taken off to reveal partially the internal configuration of the alleviate operating apparatus 5. The alleviate operating apparatus 5 is connected to the driving shaft 42 by means of a fixed base 52; the fixed base 52 is connected to a buffering spring 53; the buffering spring 53 and a passive gear 54 are connected to each other and put around the driving shaft 42.

As the driving shaft 42 rotates, the fixed base 52, the buffering spring 53, and the passive gear 54 are driven to rotate. The buffering spring 53 is disposed so as to buffer the shock due to the compression of the damper, so that the rotation of the passive gear 54 driven by the driving shaft 42 can be more uniform, with rotation pulse filtered out. When the accelerative rotating apparatus comes into play, the passive gear 54 drives a first accelerative pinion 55 engaged therewith and the first accelerative pinion 55 synchronously drives a second accelerative gear 56 to rotate. Then, the rotating second accelerative gear 56 drives a second accelerative pinion 57 engaged therewith. Thus, the second accelerative pinion 57 having an output shaft, which is connected to the generator 6 so as to drive the generator 6 to generate electricity.

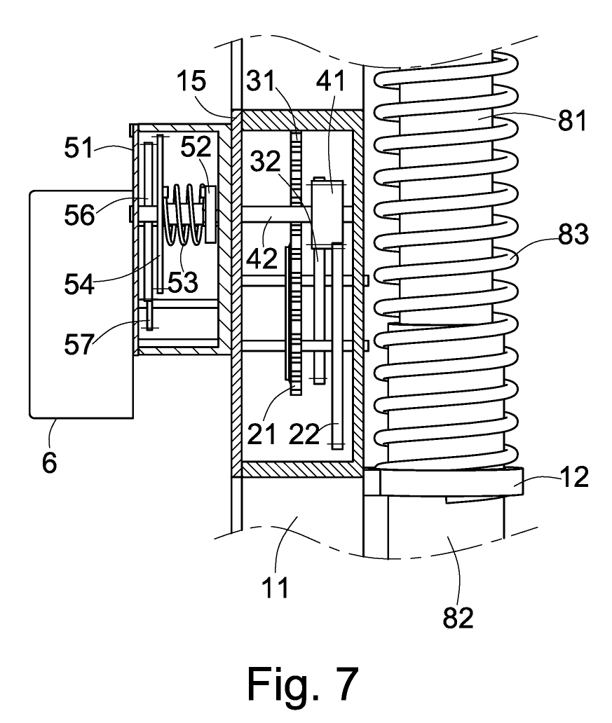

The driving apparatus 1 can be alternatively embodied so that it is connected to the alleviate operating apparatus 5 by means of the driving shaft 42 or the driving gear 41, FIG. 7 is the embodiment of the driving shaft 42 being disposed at the center of fixing base 52 while rotating the said fixing base 52; another embodiment is the alleviate operating apparatus 5 including a transfer gear directly or indirectly engaged with the driving gear 41, the buffering spring 53, and the passive gear 54, wherein the buffering spring 53 is connected to the transfer gear and to the passive gear 54 put around a shaft so that the passive gear 54 directly or indirectly drives the generator 6 to rotate for generation of electric power.

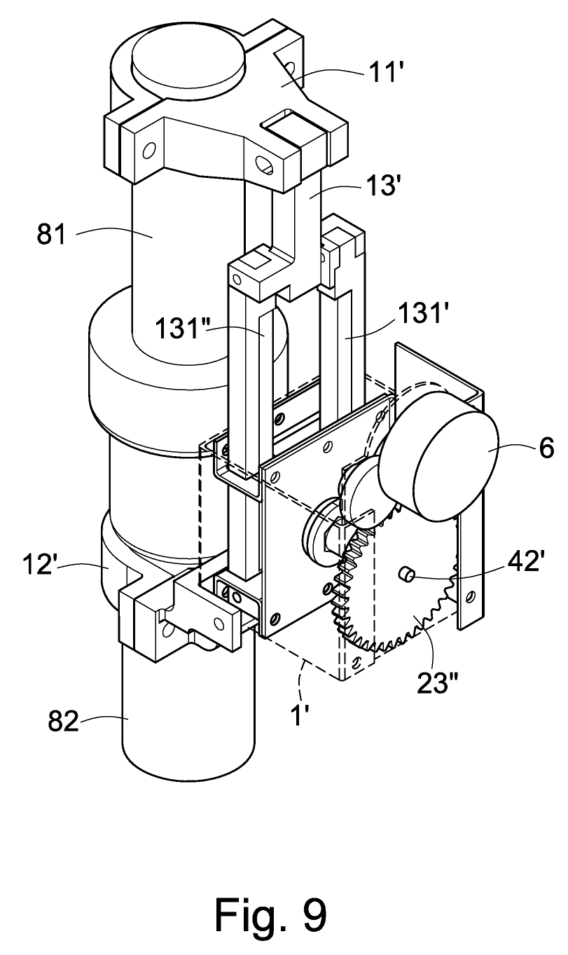

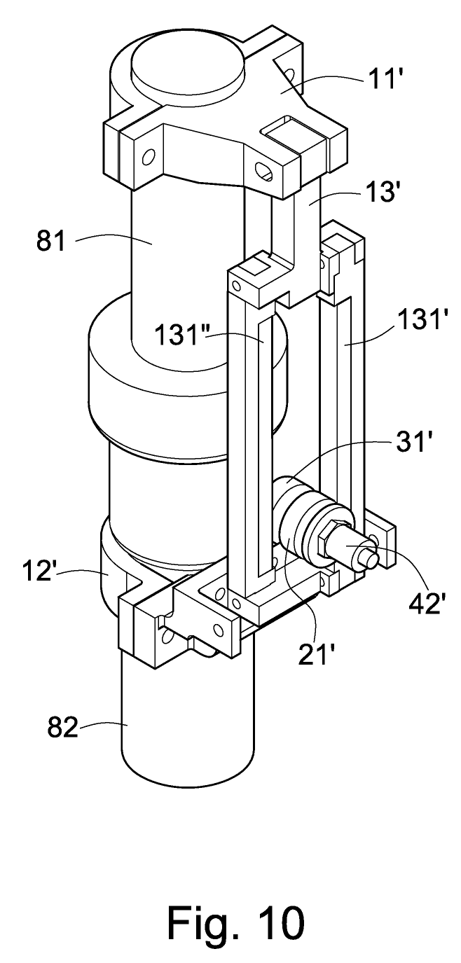

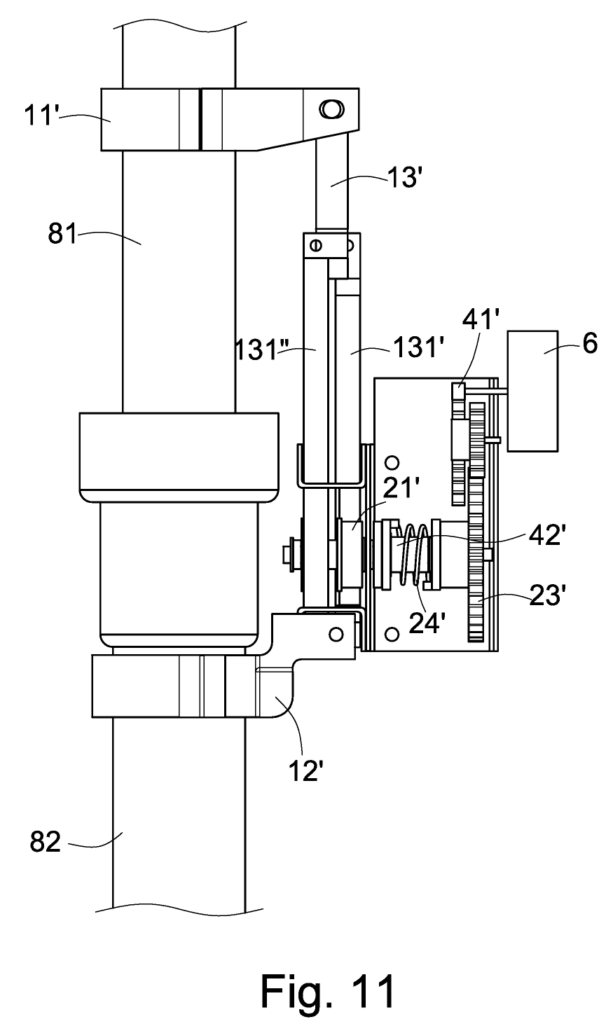

Referring to FIG. 9 to FIG. 11, a second embodiment of the damper power-generating system according to the present invention is shown. A driving apparatus 1′ is disposed on the outer tube 82 by means of a connecting base 12′. The driving apparatus 1′ has an active bar 13′ pivoted therein, wherein the active bar 13′ has one end connected to an inner tube 81 by means of a fixing base 11′ and the other end having two gear racks 131′ and 131″ disposed thereon. The gear racks 131′ and 131″ are, respectively, engaged with a first gear 21′ and a second gear 31′, each of which has a one-direction rotation driving apparatus in the same driving direction. Both of the first gear 21′ and the second gear 31′ further directly drive the driving shaft 42′ to rotate in one direction, and indirectly drive a passive gear 23′ to rotate by means of a buffering spring 24′. Thus, the passive gear 23′ synchronously drives an accelerative rotating apparatus engaged therewith, so that the accelerative rotating apparatus has a continuous one-direction rotation output to the generator 6. As the up-and-down reciprocative motions in the damper are compressed and the gear rack 131′ moves downward, the first gear 21′ driven directly drives the driving shaft 42′ to rotate clockwise whereas the second gear 31′ driven counter-clockwise cannot drive the driving shaft 42′ to rotate.

Thereafter, as the up-and-down reciprocative motions in the damper are restored and the gear rack 131″ moves upward, the second gear 31′ driven directly drives the driving shaft 42′ to rotate clockwise whereas the first gear 21′ driven counter-clockwise cannot drive the driving shaft 42′ to rotate. Therefore, the driving shafts 42′ disposed along the axes of the first gear 21′ and the second gear 31′ can drive the buffering spring 24′ to rotate in one direction; the passive gear 23′ put around the driving shaft 42′ is connected to the buffering spring 24′ so that it has a coaxial one-direction rotation output.

Moreover, multiple gears can be installed between the passive gear 23′ and the generator 6 to meet the requirement for increase or decrease of the rotation speed input to the generator 6.

What is claimed is:

1. A damper power-generating system comprising:
a damper, having an outer tube, and an inner tube being movable upward and downward within the outer tube;
a driving apparatus, for converting a reciprocative motion between the inner tube and the outer tube to one-direction rotation outputs, the driving apparatus being disposed on the outer tube by means of a connecting base, and having one two-face gear rack or two one-face gear racks formed therein and coupled to the inner tube, the gear racks being directly or indirectly engaged with two gears that are disposed on the outer tube and have one-way driving apparatuses, so that the gears directly or indirectly drive driving shafts to rotate in one direction; and
a generator, driven directly or indirectly by the driving shaft, for generation of electric power.

2. The damper power-generating system according to claim 1, wherein an alleviate operating apparatus and an accelerative rotating apparatus for cooperating with the generator are disposed between the driving apparatus and the generator, the alleviate operating apparatus being used for making uniform sudden rotation of a driving shaft when the damper acts, and the accelerative rotating apparatus being used for increasing a rotation speed that is slow when produced by the driving apparatus.

3. The damper power-generating system according to claim 2, wherein the driving apparatus is connected to the alleviate operating apparatus by means of the driving shaft, the alleviate operating apparatus including a portion of the driving shaft, a buffering spring, and a passive gear, wherein the buffering spring being connected to the driving shaft and to the passive gear put around the driving shaft so that the passive gears directly or indirectly drive the generator to rotate for the generation of electric power.

4. The damper power-generating system according to claim 2, wherein the accelerative rotating apparatus is disposed between the alleviate operating apparatus and the generator, and includes gears engaged with one another, so that the rotation speed of an output shaft meets the rotation speed of the generator.

5. The damper power-generating system according to claim 2, wherein the driving apparatus is connected to the alleviate operating apparatus by means of the driving shaft or the driving gear, the alleviate operating apparatus including a transfer gear directly or indirectly engaged with the driving gear, a buffering spring, and a passive gear, wherein the buffering spring is connected to the transfer gear and to the passive gear put around the driving shaft so that the passive gear directly or indirectly drives the generator to rotate for generation of electric power.

6. The damper power-generating system according to claim 1, wherein the driving apparatus has two one-face gear racks connected to the inner tube, the gear racks further being engaged with a first gear and a second gear that have one-way driving apparatuses and drive in the same direction and coaxially with each other, so that the first gear and the second gear directly drive the driving shafts positioned at the axes thereof to rotate in one direction.

7. The damper power-generating system according to claim 1, wherein the driving apparatus has one two-face gear rack or two one-face gear racks formed therein and coupled to the inner tube, the gear racks being directly or indirectly engaged with two gears that are disposed on the inner tube and have one-way driving apparatuses, so that the gears directly or indirectly drive the driving shafts to rotate in one direction and the driving shafts directly or indirectly drive the generator for generation of electric power.

8. A damper power-generating system, comprising:
a damper, having an outer tube, and an inner tube being movable upward and downward within the outer tube;
a driving apparatus, for converting a reciprocative motion between the inner tube and the outer tube to one-direction rotation outputs, disposed on the outer tube by means of a connecting base, and having an active bar pivoted therein, wherein the active bar has one part extending out to be movably coupled to the inner tube and the other part partially having a gear rack formed on at least one side thereof, the gear racks being engaged with two gears that are disposed on the outer tube and have one-way driving apparatuses, the axes of the gears each driving a passive gear to rotate in one direction, and the two passive gears being engaged with a driving gear and driving the driving gear to rotate in one direction, so that the passive gears drive the driving shaft at the axis of the driving gear to rotate in one direction; and
a generator, driven directly or indirectly by the driving shaft, for generation of electric power.
